(19) United States
(12) Patent Application Publication
(10) Pub. No.: US 2007/0091112 A1
(43) Pub. Date: Apr. 26, 2007

(54) Method system and program for time based opacity in plots

(76) Inventors: Patrick Louis Pfrehm, Dayton, NV (US); John Grant, Gardnerville, NV (US)

Correspondence Address: CANTOR COLBURN, LLP, 55 GRIFFIN ROAD SOUTH, BLOOMFIELD, CT, 06002, US

(21) Appl. No.: 11/254,505

(22) Filed: Oct. 20, 2005

(51) Int. Cl. G09G 5/02

(52) U.S. Cl. 345/592

(57) ABSTRACT

The disclosed method relates to conveying a time component in a data representation comprising: attaching a time stamp to a data point and calculating an opacity for said data point based upon a time component of said data point. The disclosed computer program relates to conveying a time component in a data representation comprising: receiving at least one data point with a time component, and calculating an opacity for said data point based upon the time component of said data point. The disclosed system relates to conveying a time component in a data representation comprising: attaching a time stamp to a data point, and calculating an opacity for said data point based upon at least one time component of said data point.

### TECHNICAL FIELD

An embodiment of the present invention relates to a method for plotting graphical data that includes time information not associated with either axis of the plot.

### BACKGROUND OF THE INVENTION

Data that exists in tables or spreadsheets is commonly graphed in order to make the analysis of what the data can reveal more easily and quickly understood. One of the most common types of graph is an X versus Y scatter plot hereafter referred to as “scatter plot.”

Scatter plots can be used to display two related sets of data on a single chart. This is particularly helpful if you want to make predictions based on the data. For example from a plot of height versus weight for an average male you could predict the average weight of males for a particular average height from such a plot. However such a graph is limited as to what can be learned from it when looking for trends over a period of time.

For example, if the height versus weight data were available for several years and you wanted to know if the relationship of height versus weight had changed over a time. A single scatter plot could provide this information in the following way. If the data from different years is represented by different colors or different symbols on the graph, then, by referring to a legend that defines which color or symbol refers to which year; you could perform the analysis. This method has the drawback of requiring the operator to perform some analysis or specific activity to determine the age of the data on the plot.

Accordingly, there is a need in the art for a method of determining the relative age of data points on a plot without having to perform any analysis.

### BRIEF DESCRIPTION OF THE INVENTION

The disclosed method relates to conveying a time component in a data representation comprising: attaching a time stamp to a data point and calculating an opacity for said data point based upon a time component of said data point.

The disclosed computer program relates to conveying a time component in a data representation comprising: receiving at least one data point with a time component, and calculating an opacity for said data point based upon the time component of said data point.

The disclosed system relates to conveying a time component in a data representation comprising: attaching a time stamp to a data point, and calculating an opacity for said data point based upon at least one time component of said data point.

### BRIEF DESCRIPTION OF THE DRAWINGS

The following descriptions should not be considered limiting in any way. With reference to the accompanying drawings, like elements are numbered alike:

FIG. 1 is a scatter plot of an embodiment of the present invention;

FIG. 2 is a spreadsheet containing data for the scatter plot of FIG. 1;

FIG. 3 is a flow chart for a process of an embodiment of the present invention; and

FIG. 4 is a block diagram of a system that may be utilized to perform the process depicted in FIG. 3.

### DETAILED DESCRIPTION OF THE INVENTION

A detailed description of several embodiments of the disclosed apparatus and method are presented herein by way of exemplification and not limitation with reference to the Figures.

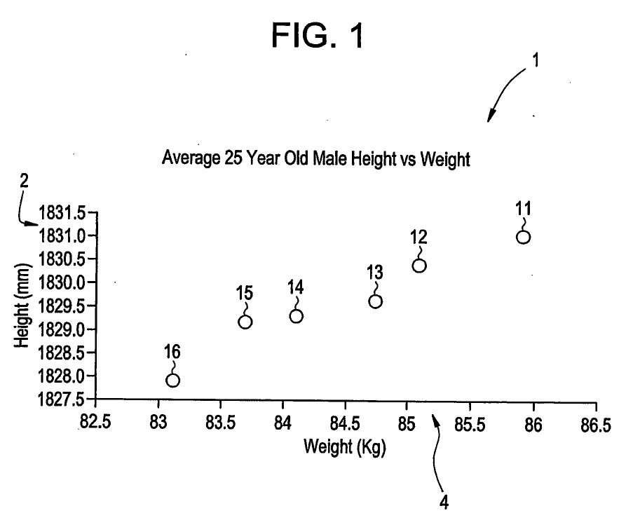

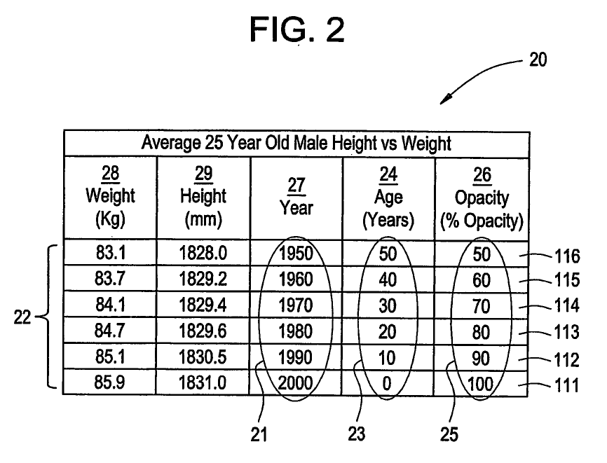

Referring to FIG. 1, a data representation in accordance with an embodiment of the present invention is shown in the form of a scatter plot 1 of data on a coordinate system. The coordinate system consists of two axes, a vertical Y-axis 2 and a horizontal X-axis 4. Symbols 11-16 representing data points are plotted on the coordinate system according to an X data value and a Y data value for each data point. The symbols 11-16 used here are dots but any symbol may be used. The opacity of the symbols varies from 100% opaque to some lower level of opacity that renders the symbols less visible. The level of opacity for each data point is proportional to the age of that particular data point thereby providing a time component 23 as shown in FIG. 2. Thus a user may, by viewing a graph made with a process of an embodiment of the present invention, determine whether a trend over time exists and if so what that trend may be for data plotted on axes that do not pertain to the age of the data plotted, thereby conveying a time component on a data representation.

The proportionality between age and opacity can be a linear function, a logarithmic function or any other function a user chooses including a plurality of different functions. The proportionality of opacity to age may be directly proportional, such that the older data points are less opaque than newer data points, or inversely proportional such that older data points are more opaque than the newer data points. The opacity may also be user defined for each individual data point thereby creating an estimated proportionality. Defining a proportionality function with computer software has the advantage of letting the computer calculate the opacity for each data point as opposed to performing the calculations manually.

Referring again to FIG.1 and to the spreadsheet of data in FIG. 2 that was used to create FIG. 1, the relationships between the spreadsheet 20 of data and the plot 1 are shown. Each data point 22 in the spreadsheet 20 contains the data for a for a given year. For example, for a time stamp 21 of the year 1950 the average 25 year old male weighed 83.1 Kg and was 1828.0 mm in height, and for the time stamp 21 of the year 1960 the average 25 year old male weighed 83.7 Kg and was 1829.2 mm in height. The average weight and height data continues for the years 1970, 1980, 1990 and 2000 in spreadsheet 20.

A fourth column 24 labeled ‘Age (years)’ of the spreadsheet 20 lists a time component 23 specifically the age of the data in each row relative to a user specified time frame, which in this example, is the year 2000. A fifth column 26 of the spreadsheet 20 labeled ‘Opacity (% opacity)’ lists the opacity value 25 that will be used to plot the data point for that particular row of data. In the spreadsheet 20 the value for % opacity is calculated from the function:
% Opacity=100−Age

Thus for the year 1950 the % Opacity=100−50=50. This function can be put into column 26 so that the value is automatically calculated from the data in ‘Year’ column 27.

Through the use of software modified to plot data points with varying levels of opacity in accordance with an embodiment of the present invention, the data in the spreadsheet 20 is graphed in scatter plot 1. The software modification involves new commands that permit a user to assign opacity values from a data set to data points that are to be plotted. In the example of FIGS. 1 and 2, the data set containing the opacity values are the values in column 26 labeled Opacity (% opacity), and the data points that these opacity values are assigned to are the data values from columns 28 and 29 labeled ‘Weight (Kg)’ and ‘Height (mm)’, respectively.

Referring now to the scatter plot 1 of FIG. 1, the varying opacity of the six plotted points 11-16 is observed. Data point 11 is from the year 2000 and therefore has a 100% time component 23 opacity value 111 assigned to it per column 26 of the spreadsheet 20. The corresponding plotted symbol for data point 11 is observed to be very dark (100% opaque). Similarly, data point 12 is less dark due to the 90% time component 23 opacity value 112 assigned to it in column 26. Data points 13, 14, 15 and 16, have the corresponding time component 23 opacity values 80%, 70%, 60% and 50% assigned per opacity values 113, 114, 115 and 116 respectively.

With the aforementioned knowledge of the data presented in the scatter plot 1 a cursory review of the scatter plot 1 reveals that a trend exists. The trend over the past 50 years has been an increase in the average height and weight of 25 year old males. More specifically, one can tell that the increases in both height and weight have occurred in every one of the past five decades. By using varying levels of opacity for the varying ages of data points one can readily determine the relative age of different data points without having to refer to key to see which color or symbol, for example, represents which age

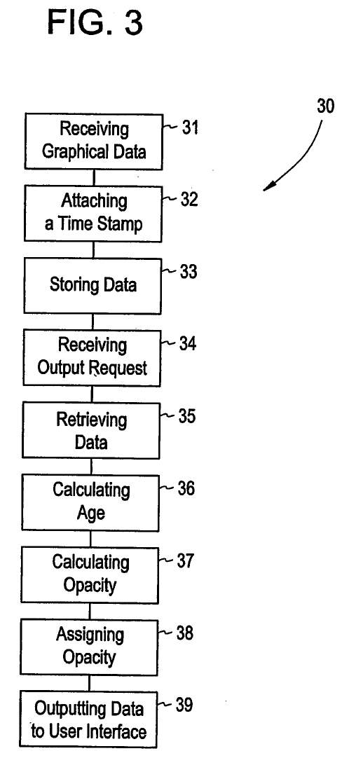

Referring to FIG. 3, a flow chart 30 of process steps of an embodiment of the present invention is shown. The process comprises several steps with step one being a receiving of graphical data points 31 into a computer system. A second step involves attaching a time stamp 32 to each graphical data point corresponding to a time when the data was generated or received. Step three is storing the graphical data points 33 and the time stamps for later retrieval. Step four consists of receiving a request for output 34 from an operator. Step five involves retrieving of data points and time stamps 35 for purposes of calculating an age 36 for each graphical data point relative to a specified time frame. In step seven a calculating of opacity 37 is performed based on proportionality to the age calculated in step six. An eighth step is an assigning of opacity 38 to each respective graphical data point according to the calculation of step seven. And step nine is an outputting of data 39 for display on a user interface where the data symbols and their associated opacity levels can be observed.

The sequential order of the nine steps described above is only an illustration of one embodiment of the present invention. The step numbers given are for purposes of distinguishing one step from another and are not used to define an order. Other embodiments of the present invention may have the nine steps in various other orders as well as omit some steps or add some steps while still remaining within the scope of the present invention. For example, the receiving of an output request may come before any data is received, or it may come after all the data has been received.

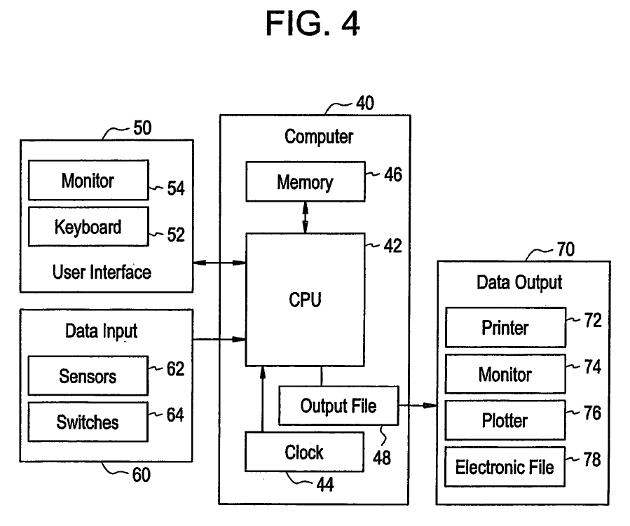

FIG. 4 is a block diagram of a system in accordance with the flow chart of FIG. 3. A user, through interface 50, sets parameters for data input 60 and data output 70 from a computer system 40. A keyboard 52 and monitor 54 permit the user to interface with the computer graphing software running in CPU 42. Data input 60 can be fed directly into the CPU 42 from sensors 62 such as pressure sensors, thermocouples, force transducers, etc. and switches 64 such as temperature switches, pressure switches, etc., or can be manually input by an operator through interface 50. Computer software running in CPU 42 allows input ranges of voltage for example to be set that correspond to the output of the particular sensor being used.

As the CPU 42 receives data from the data input 60 it will immediately attach a time stamp from clock 44 to each data point and send the data point and the time stamp to be stored in memory 46. This process can proceed indefinitely. When a request for information regarding the data is made, for example, to plot the pressure versus temperature from a start time to an end time with opacity of the data points being proportional to the age of the data points according to a certain algorithm, the following takes place. The CPU 42 retrieves the data points from memory 46 calculates the age of the data points and calculates the opacity according to the defined algorithm and assigns an opacity to each data point relative to the age from the end time. The user may also use the start time in addition to the end time in the determination of opacity by having the computer calculate a time percentage relative to a time window defined by the start and end times.

The following is an example of an algorithm for determining an opacity value for data points relative to a time window. The source of the data is not important for the purposes of the example and will therefore not be discussed.
let T1=time at the beginning of the time window;
let T2=time at the end of the time window;
let Tn=the time stamp of an nth data point;
let An=relative age of point n to time window;
calculate the relative age for point n: An=(Tn−T1)/(T2−T1)
let PQn=be the opacity value for data point n; where
let PQmin=60 be a defined minimum opacity value, and
let PQmax=255 be a defined maximum opacity value; where the opacity values have the following correlation:
opacity of 60=transparency of 76%, and Opacity of 255=transparency of 0%;
let PQn=opacity at point n;
calculate PQn=An*2*PQmax;
assign the opacity of point n: if the opacity is less than the minimum opacity, set the opacity to the minimum opacity value: If PQn<60 Then set PQn=60;
and if the opacity is more than the maximum opacity, set the opacity to the maximum opacity value: If PQn>255 Then set PQn=255.

The above algorithm assigns values to the data as follows: If the data point is from 50% or later in the time window, the data point is assigned the maximum opacity (255 in this example), if the data point lies within the first 11.8% of the time window, then the data point is assigned the minimum opacity (60 in this example). However, if the data point lies between 11.8% and 50% of the time window, the opacity increases from the minimum opacity to the maximum opacity in a linear function as defined in the calculation for opacity stated above.

Based on a user's request for output the CPU 42 will retrieve all data points from T1 through T2 and their corresponding time stamps from memory 46. It will calculate the age of the data point relative to the time window requested and, based on the algorithm defined, assign an opacity value to each of the data points. The CPU 42 will then create an output file 48 for outputting to the output device 40 specified by the user. Printers 72, monitors 74, plotters 76 and electronic files 78 are representative of a partial list of possible output devices 70.

In the above example transparency values are given that correlate to certain opacity values since many existing software programs have the capability of displaying and outputting features with varying levels of transparency and not opacity.

Opacity can be thought of as the inverse of transparency, which means that a low level of opacity is highly transparent and will therefore let details of what is behind the symbol show through the symbol. For purposes of embodiments of the present invention, the word opacity will cover this condition as well as a second condition. The second condition is when a symbol is lighter in shade such that it appears more transparent however it is still 100% opaque in the sense that no details of objects behind show through the symbol. Throughout this disclosure the term opacity covers both meanings. Therefore, a low opacity can result in a light image that shows some details of what is behind it and a low opacity can result in a light image that shows no details of what is behind it.

Another embodiment of the present invention may plot a continuous line instead of discreet symbols. Such a line may include automatic smoothing features such as spline curves for example or may use straight lines between discreet data points. In this example the opacity of the line will vary based on the age of the data points nearest the line.

Although embodiments presented above reference a two axes coordinate system it should be understood that embodiments of the present invention are not limited to such a coordinate system. In fact coordinate systems with just one or more than two axes as well as any other system of graphing data may be employed in other embodiments of the present invention.

As described above, embodiments may be in the form of computer-implemented processes and apparatuses for practicing those processes. In exemplary embodiments, the invention is embodied in computer program code. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. The technical effect of the executable instructions is to convey a time component in a data representation through variations in opacity values for the graphical data points.

While the embodiments of the disclosed method have been described with reference to exemplary embodiments, it will be understood by those skilled in the art that various changes may be made and equivalents may be substituted for elements thereof without departing from the scope of the embodiments of the disclosed method. In addition, many modifications may be made to adapt a particular situation or material to the teachings of the embodiments of the disclosed method without departing from the essential scope thereof. Therefore, it is intended that the embodiments of the disclosed method not be limited to the particular embodiments disclosed as the best mode contemplated for carrying out the embodiments of the disclosed method, but that the embodiments of the disclosed method will include all embodiments falling within the scope of the appended claims.

What is claimed is:

1. A method for conveying a time component in a data representation comprising:
attaching a time stamp to a data point; and
calculating an opacity for said data point based upon the time component of said data point.

2. The method of claim 1 further comprising:
displaying said data point in said representation at the calculated opacity level.

3. The method of claim 1 further comprising:
using proportionality in calculating the opacity for the data points.

4. The method of claim 1 further comprising:
determining the time component includes calculating a percentage of time of the time stamp relative to a time window.

5. The method of claim 1 further comprising:
determining the time component includes calculating its age relative to a specified time.

6. The method of claim 1 further comprising:
Plotting the data on an X versus Y graph with the data points being represented by symbols with opacity levels proportional to the age of the data points.

7. A computer program product for conveying a time component in a data representation in a computer environment, the computer program product comprising a storage medium readable by a processing circuit and storing instructions for execution by the processing circuit for facilitating a method comprising:
receiving at least one data point with a time component; and
calculating an opacity for said data point based upon the time component of said data point.

8. The computer program of claim 7 further comprising:
displaying said data point in said representation at the calculated opacity level.

9. The computer program of claim 7 further comprising:
receiving the data point automatically from at least one sensor.

10. The computer program of claim 7 further comprising:
receiving a data representation output request; and
outputting the requested data representation with the various opacities for the data points for display on a user interface device.

11. The computer program of claim 7 further comprising:
storing the data point and the time stamp in memory;
retrieving data points and time stamps from memory; for calculating an age of the data point relative to a time frame.

12. The computer program of claim 11 further comprising:
calculating an opacity level for each graphical data point proportional to the age of the data point; and
assigning the opacity level to each corresponding data point.

13. The computer program of claim 11 further comprising:
calculating an opacity level for each graphical data point relative to the age of the data point according to a user defined algorithm.

14. A system for conveying a time component in a data representation comprising:
attaching a time stamp to a data point; and
calculating an opacity for said data point based upon at least one time component of said data point.

15. The system of claim 14 further comprising:
displaying said data point in said representation at the calculated opacity level.
